(19) United States
(12) Patent Application Publication
(10) Pub. No.: US 2014/0047731 A1
(43) Pub. Date: Feb. 20, 2014

(54) Dryer Conveyor Speed Control Apparatus and Method

(71) Applicant: M&R Printing Equipment, Inc., Glen Ellyn, IL (US)

(72) Inventors: Brian Quirk, Aurora, IL (US); Bernabe Mauban, Hanover Park, IL (US)

(73) Assignee: M&R Printing Equipment, Inc., Glen Ellyn, IL (US)

(21) Appl. No.: 13/967,564

(22) Filed: Aug. 15, 2013

Related U.S. Application Data
(60) Provisional application No. 61/684,244, filed on Aug. 17, 2012.

(51) Int. Cl. F26B 25/00

(52) U.S. Cl. CPC F26B 25/001
USPC 34/282; 34/560

(57) ABSTRACT

In one embodiment, a conveyor speed control system for a dryer is provided. The system includes a dryer having a housing with an entrance and an exit, and a conveyor within the housing, the conveyor capable of moving at a desired speed. A sensor senses the temperature of the interior of the dryer housing. A controller is provided. The controller receives a signal from the temperature sensor. The controller also controls the speed of the conveyor, and limits the speed of the conveyor to a desired speed until a desired dryer housing temperature is attained.

### CROSS-REFERENCE TO RELATED APPLICATIONS

The present application claims the benefit of U.S. Provisional Patent Application Ser. No. 61/684,244, filed Aug. 17, 2012, the contents of which are incorporated herein by reference.

### FEDERALLY SPONSORED RESEARCH OR DEVELOPMENT

N/A

### TECHNICAL FIELD

The present invention generally relates to an apparatus and method for controlling the conveyor speed of a textile dryer upon startup to conserve energy.

### BACKGROUND OF THE INVENTION

Indicia applied to articles of clothing and other textiles have become very popular. Fanciful indicia, such as slogans, logos, college names, sports team names and logos, and sayings are commonplace.

Indicia are printed using screen printing machines, with one or more colors. Typically, a screen printing machine has at least one station to print each color. Each station generally includes a printing head, which supports a single screen, the ink, and a mechanism for applying the ink to the textile or substrate. The textile to be printed travels between printing stations. The textile is typically carried by a metal pallet, pallet support, flat bed, or platen. Common printing machines are of the turret-type, or are oval or linear in configuration.

Some printing machines incorporate ink curing stations. Other operations employ separate dryers. A dryer has two primary components: a conveyor system and a heating system. Typically, the drying operation includes an operator setting the internal dryer temperature and the conveying speed to achieve the desired drying characteristics. Commonly known mechanisms are employed to determine or read the ambient temperature in the dryer, which allows the operator to adjust the conveyor speed to compensate to achieve the desired drying.

Numerous inks are available. Such inks include water based inks, sublimation inks, and plastisol. The ink is cured or gelled onto the substrate to a critical temperature. The temperature during the curing process must be kept within a suitable window depending on the ink's curing properties, typically between 125 and 450 degrees Fahrenheit. For example, plastisols must reach a temperature of 320 degrees Fahrenheit. In the ranges below 320 degrees and above 350 degrees, the plastisol will not properly set, resulting in cracking, or it may become liquified. Moreover, if a dye in the textile is overheated, it will migrate, or the textile or substrate may scorch or burn, increasing waste and production costs.

To solve this issue, dryers such as disclosed in U.S. Pat. No. 5,937,535 were developed to sense and control the drying process. Dryers are typically electric or gas-powered, use a great deal of energy, and are essentially a heat sink. The present invention provides an improved belt control system that reduces the amount of energy the dryer uses on startup, thereby reducing energy consumed in the drying process, and cutting costs of operation.

### SUMMARY OF THE INVENTION

In one embodiment, a conveyor speed control system for a dryer is provided. The system includes a dryer having a housing with an entrance and an exit, and a conveyor within the housing, the conveyor capable of moving at a desired speed. A sensor senses the temperature of the interior of the dryer housing. A controller is provided. The controller receives a signal from the temperature sensor. The controller also controls the speed of the conveyor, and limits the speed of the conveyor to a desired speed until a desired dryer housing temperature is attained.

In another embodiment, a process for drying is provided. The process includes the steps of warming up a dryer at a first conveyor speed until a desired dryer temperature is attained, and operating the dryer at a second conveyor speed faster than the first conveyor speed.

In a further embodiment, a process for operating a dryer is provided. The dryer has a housing and a conveyor capable of moving at a desired speed within the housing. The process includes the step of warming up the dryer housing until a desired temperature is attained. The process also includes the steps of controlling the conveyor speed at a first conveyor speed before the desired temperature is attained, and controlling the conveyor speed at a second conveyor speed faster than the first conveyor speed after the desired temperature is attained.

### BRIEF DESCRIPTION OF THE DRAWINGS

To understand the present invention, it will now be described by way of example, with reference to the accompanying drawings in which:

FIG. 1 is a perspective view of a typical dryer used with the belt control system of an embodiment of the present invention.

FIG. 2 is a sectional view of the dryer along line 2-2 of FIG. 1.

FIG. 3 is a sectional view of the dryer along line 3-3 of FIG. 1.

FIG. 4 is a schematic view of a belt control system in accord with an embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

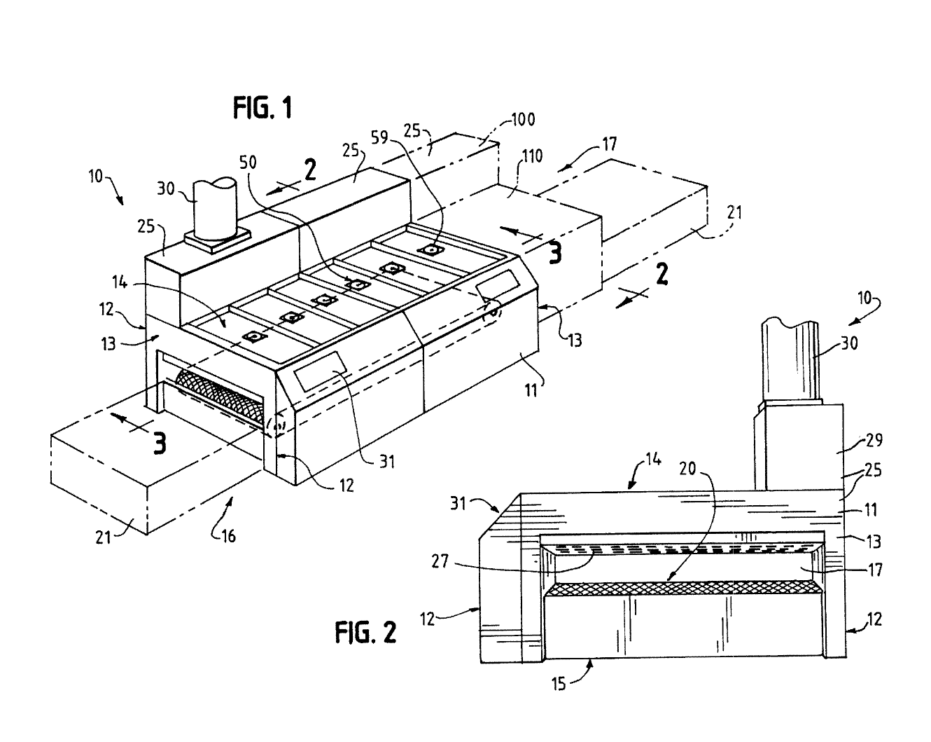

Referring to the Figures, FIG. 1 shows a dryer 10 of an embodiment of the present invention. The dryer 10 is of a type generally described in U.S. Pat. No. 5,937,535, incorporated herein by reference, and from which FIG. 1 is reproduced. The dryer 10 includes a dryer housing 11 wherein the products passing therethrough are heated. The housing 11 is formed of opposed side walls 12, opposed end walls 13, a top wall 14 and a bottom wall 15. Such walls are generally constructed of sheet metal and with a double wall to keep the outer wall cool. At one end of the housing there is an entrance 16 and at the other end there is an exit 17. These entrances and exits are generally openings within the walls. A conveyor system 20 (here a looped belt with a plurality of aperture therein (as a screen)) is driven by a motor (not shown) and passes through the housing 11 between the side 12, top 14 and bottom 15 walls from the entrance 16 to the exit 17. The ductwork for the system is generally shown at reference number 25. A cooling/dehumidifying/chilling section 100 is also added. The conveyor 20 shown is totally retained within the dryer housing 11. Some conveyors extend beyond these openings to points outside the housing (shown in phantom—reference number 21 in FIG. 1).

Heater elements (shown schematically at reference number 22) are within (generally below the conveyor 20) or immediately adjacent the dryer housing 11. An intake blower and an in-line blower are positioned within or adjacent the housing. Ducts (represented by duct openings 26) bring the air into the dryer housing 11 above the conveyor 20. There are generally two blowers employed. One blower draws fresh atmospheric air into the system to mix with the gas and burn, and the second blower moves the heated air into the heating area above the conveyor.

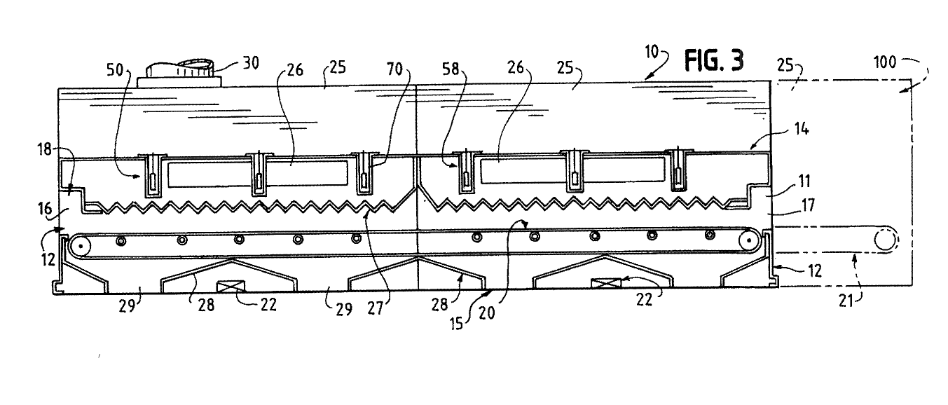

In the embodiment shown, there are four (4) “zones” shown. The first zone (preheating zone) is just after the inlet 16 and in the vicinity of the separate infrared preheater 18 (FIG. 3). The second zone is in the vicinity of the first opening 26 for the heated air. The third zone is in the vicinity of the second opening 26 for the heated air. And, the fourth zone is in the chilling section (shown in phantom at 100). A plurality of overlapping heating air knives 27 (with slits therein) (FIG. 2) are disposed between the conveyor 20 and the duct openings 26 to the intake blowers and the heating elements 22 for ensuring consistent airflow and velocity to and across the entire width of the conveyor 20. As a result, heated, forced air is blown across the conveyor 20 and any products thereon.

A plurality of inclined deflectors 28 are located below the conveyor 20 for directing the air passing through the housing 11 and conveyor 20 to exhaust ducts (represented by duct openings 29). An exhaust blower is connected to the exhaust ducts 29 to transport the exhaust air to either a stack 30 for release into the surrounding atmosphere or back into the system 10 to recirculate the heated air and increase the assembly's efficiency.

While not shown, a circulation blower and blower filter screens are also employed. The system is also insulated to ensure safe use thereof.

In most systems, there is a means to detect the temperature inside the housing. Such means include industrial grade thermometers that measure the ambient air within the housing. This information is fed to the control panel 31 and displayed and assists an operator in deciding whether to manually adjust the conveyor's speed, the heat applied, and/or the air movement (cubic feet per minute—“CFM”).

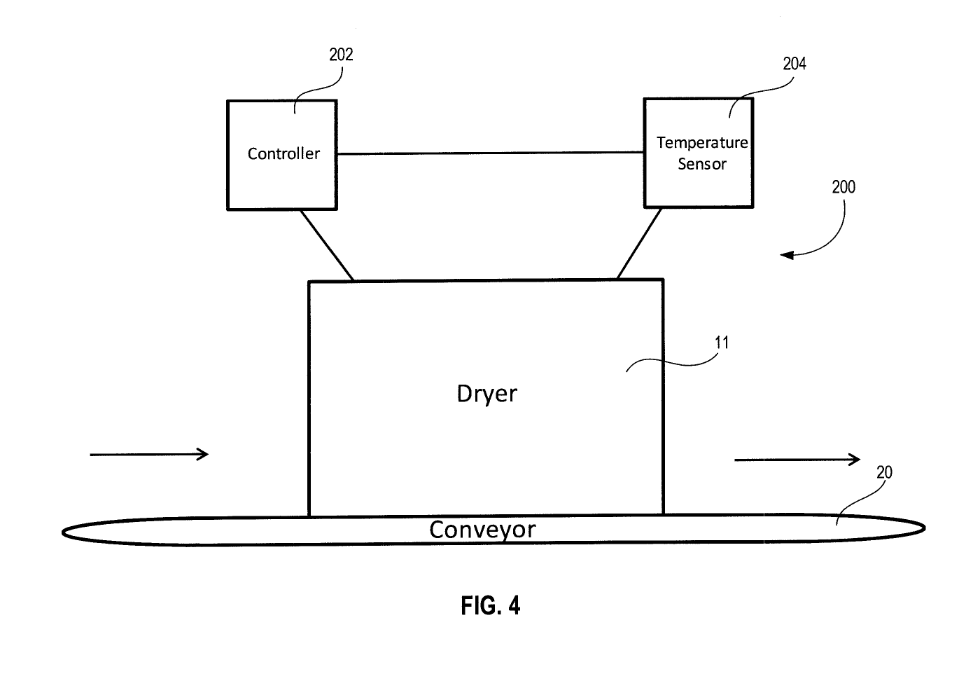

FIG. 4 is a schematic showing an embodiment of a belt control system 200 of the present invention. The system 200 includes the dryer housing 11 and conveyor 20. Screen printed articles are placed on the conveyor 20 and through the dryer housing 11 for drying and/or curing of the ink. The speed of the conveyor 20 is controlled by a controller 202. The controller 202 controls the speed of the conveyor 20 when the dryer 10 is first turned on to limit the conveyor 20 speed to a desired speed until the dryer housing 11 reaches its prescribed working temperature. The temperature is sensed by one or more temperature sensors 204 connected to the controller 202. It is desired to run the conveyor 20 while the dryer housing 11 is heating up to also heat up the conveyor 20. It has been found, as described below, that limiting the conveyor 20 speed on startup until the dryer housing 11 has obtained its working temperature, approximately 375 degrees Fahrenheit, results in energy and cost efficiencies and savings. After the dryer housing 11 has reached its desired working temperature, the speed of the conveyor 20 is increased as controlled by the controller 202.

Below is a chart of test results of natural gas usage and time to an operating temperature of 375 degrees Fahrenheit for a Sprint 60 dryer manufactured by M&R Printing Equipment, Inc., of Glen Ellyn, Ill., at a belt speed of three feet per minute versus twenty feet per minute.

| Conveyor Speed 3 FPM | | | | | Conveyor Speed 20 FPM | | | |
|---|---|---|---|---|---|---|---|---|
| | | Usage | | | | | Usage | Time |
| Meter | | (cubic | Time to | | Meter | | (cubic | to |
| Readings | | feet) | 375 F. | | Readings | | feet) | 375 F. |
| 312 | 351 | 39 | 7.1 | min | 351 | 401 | 50 | 9.0 min |
| 401 | 439 | 38 | 7.1 | min | 439 | 490 | 51 | 9.0 min |
| 490 | 529 | 39 | 7.25 | min | 529 | 579 | 50 | 9.0 min |
| 579 | 618 | 39 | 7.0 | min | 618 | 669 | 51 | 9.0 min |

| | | | |
|---|---|---|---|
| Average | 38.75 | Average | 50.5 |

As the chart above shows, the average natural gas usage for warming up the dryer from 150 to 375 degrees Fahrenheit at 20 feet per minute was 50.5 cubic feet. The average natural gas usage at 3 feet per minute was 38.75 cubic feet, a difference of 11.75 cubic feet. Moreover, the dryer heated up to 375 degrees approximately 2 minutes faster at a belt speed of 3 feet per minute versus 20 feet per minute. That equates to a 22% time reduction and a 23% gas consumption reduction.

While the specific embodiments have been illustrated and described, numerous modifications come to mind without significantly departing from the spirit of the invention, and the scope of protection is only limited by the scope of the accompanying Claims.

What is claimed is:

1. A conveyor speed control system for a dryer comprising:
a dryer having a housing with an entrance and an exit;
a conveyor within the housing, the conveyor capable of moving at a desired speed;
a sensor for sensing the temperature of the interior of the dryer housing; and
a controller, the controller receiving a signal from the temperature sensor, the controller also controlling the speed of the conveyor, the controller further limiting the speed of the conveyor to a desired speed until a desired dryer housing temperature is attained.

2. The system of claim 1 wherein the first conveyor speed is approximately three feet per minute.

3. The system of claim 1 wherein the second conveyor speed is approximately twenty feet per minute.

4. A process for drying comprising the steps of:
warming up a dryer at a first conveyor speed until a desired dryer temperature is attained; and
operating the dryer at a second conveyor speed faster than the first conveyor speed.

5. The process of claim 4 wherein the first conveyor speed is approximately three feet per minute.

6. The process of claim 4 wherein the second conveyor speed is approximately twenty feet per minute.

7. A process for operating a dryer, the dryer having a housing and a conveyor capable of moving at a desired speed within the housing, the process comprising the steps of:
warming up the dryer housing until a desired temperature is attained;
controlling the conveyor speed at a first conveyor speed before the desired temperature is attained; and
controlling the conveyor speed at a second conveyor speed faster than the first conveyor speed after the desired temperature is attained.

8. The process of claim 7 wherein the first conveyor speed is approximately three feet per minute.

9. The process of claim 7 wherein the second conveyor speed is approximately twenty feet per minute.
